(19) United States
(12) Patent Application Publication
(10) Pub. No.: US 2015/0210872 A1
(43) Pub. Date: Jul. 30, 2015

(54) COLOURED COMPOSITION SCREEN-PRINTABLE ON A SHEET OF POLYMER MATERIAL

(71) Applicant: SAINT-GOBAIN GLASS FRANCE, Courbevoie (FR)

(72) Inventors: Sébastien Wery, Talence (FR); Elodie Ducourthial, Compiegne (FR); Jérome Rami, Thourotte (FR); Benoît Barbier, Jette (BE); Camille Dassonville, Noyon (FR); Angélique Morel, Compiegne (FR)

(21) Appl. No.: 14/419,042

(22) PCT Filed: Jul. 22, 2013
(86) PCT No.: PCT/FR2013/051760

§ 371 Date: Feb. 2, 2015

(30) Foreign Application Priority Data
Jul. 31, 2012 (FR) 1257429

(51) Int. Cl. C09D 11/106; C09D 11/037; B05D 5/06

(52) U.S. Cl. CPC C09D 11/106; B05D 5/06; C09D 11/037; B05D 2201/02; B05D 2201/04; B05D 2506/20

(57) ABSTRACT

A laminated glazing includes a sheet of polymer material color printed, via screen printing, using a composition including 10% to 15% by weight of polyvinyl butyral; 32% to 45% by weight of at least one solvent predominantly consisting of at least one aliphatic dicarboxylic acid diester, and at least one white pigment in an amount and with a specific surface area that are selected so that the Brookfield viscosity of the composition at 20° C. is between 9 and 13 Pa·s.

The invention relates to the field of laminated glazings, commonly consisting of:
two sheets of glass bonded to one another by means of a plastic interlayer, such as a sheet of polyvinyl butyral, or ethylene/vinyl acetate copolymer, etc., or
one sheet of glass and one sheet of polycarbonate bonded to one another by an interlayer sheet of polyurethane, or
a single sheet of mineral glass or of polycarbonate, bonded to which is a sheet of polyurethane, etc.

Laminated glazings, as used as motor vehicle windshields or the like, have many uses: a layer that reflects solar radiation, making it possible to lower the temperature of the instrument panel and the ambient temperature in the passenger compartment, a support for the interior rearview mirror, electric current feed busbars especially for an ITO layer or a network of heating wires, an upper strip that filters solar radiation of optionally graduated coloration, a rain detector, etc. Laminated glazings are thus printed for various purposes: edge of the glazing opacified over its entire periphery in order to protect the underlying adhesive from UV radiation and hide the body components or seals from the view of an observer outside of the vehicle, markings relating to the manufacturer, or to various standards, opacified surface in order to hide the base of the interior rearview mirror from the view of an observer outside of the vehicle.

It is customary to produce such printing on sheets of flat glass, that is to say, where appropriate, before bending operations (this is because it is much more difficult to print onto curved surfaces). One preferred process is the screen printing of enamel: it is able to provide the required optical qualities: good coverage, opacity and resolution, and can be easily industrialized.

Screen printing onto sheets of flat glass is not without drawbacks. In a laminate, the enamel is screen printed on the inner face of the glass sheet intended for the external position, that is to say in contact with the atmosphere, referred to as face 2, and/or on the outer face of the glass sheet intended for the internal position, referred to as face 4, which is in contact with the internal atmosphere, in particular with the passenger compartment of a transport vehicle.

The drawbacks of enameling on face 2, inside in the structure of the assembled laminate, may be described in the following manner. The sheets of glass, during the bending thereof, in pairs, come into physical contact with one another despite the presence of interlayer powder, or with mechanical components of the bending equipment. This physical contact requires the prior use of an additional furnace for the annealing of the printed composition, in order to prevent the printed surfaces that are insufficiently hardened and dried from being adversely affected: bonding of the two glass sheets, despite the separation due to the interlayer powder, creation of defects at the surface of the non-hardened enamel, for example. This annealing is an additional step of the process which generates an additional cost in the production line.

In the enameling of face 4, outside in the structure of the assembled laminate, the curing of the enamel leads, in a known manner, to the creation of an optical defect (in German: “Brennlinie”).

Other drawbacks common to these enamelings of faces 2 and 4 exist.

Firstly, it is necessary to define a perfectly adapted and differentiated heating for the enameled zones on the one hand and the non-enameled zones on the other hand, since the enamel does not absorb the same amount of heat as the glass. The heating must thus be modified for each configuration of laminated glazing, of windshield, with and without rain detector, light detector, etc.

Furthermore, the density of the black enamel after curing is of the order of 3. However optical densities slightly greater than this value may be required, which can only be obtained by increasing the thickness of enamel deposited.

These problems could be solved by carrying out the screen printing on the sheets of polymer material included in the composition of a laminated glazing, such as interlayer adhesives, like polyvinyl butyral sheets, and no longer on the glass sheets.

Obviously, this modification of the process must not in any case adversely affect the specifications of the final product: compliance with standards and client specifications, not only from a mechanical strength or aging point of view, but also from an esthetic point of view. Mention should in particular be made of:
good coverage, which is expressed by a small amount of pinholes that do not affect the transparency in an unacceptable manner,
a required opacity corresponding to an optical density at least equal to 3, preferably to 4, as measured by an X-Rite 341 device or the like,
a printing resolution and appearance that are acceptable for the client, i.e. similar to those of enameling on the glass.

Moreover, the invention is more particularly devoted to colored printing, by which reference is made here to printing other than black, and in particular: gray, white, blue, green, red, yellow, etc., this printing corresponding to an increasing demand for personalization of vehicles, either from an esthetic point of view or from a technical point of view, it being possible for one particular color to indicate, for example, an electric vehicle, etc. However, “enamel” technology does not make it possible to respond to motor vehicle problems, for several reasons. For red, orange or yellow shades, due to EHS (environment, health & safety) issues, since the standard enamels contain cadmium in order to have these bright colors, using them is henceforth prohibited. Cadmium-free red, orange or yellow enamels exist but are pastel shades and have an optical density well below 3.

Regarding blue or green metallized shades, the optical density is insufficient. In order to guarantee the optical density of 3, it is necessary to carry out double printing with black printing behind the colored enamel. This complicates the process and increases the costs (price of raw materials or else potential loss of efficiency in the production lines).

The objective of the invention is therefore the provision of a process of colored screen printing onto a sheet of polymer material of a laminated glazing, having the combination of the aforementioned advantages, in particular that can be carried out in a single pass with “touch-dry” times that do not exceed 30 minutes, preferably 10 minutes, and in particular 5 minutes. The drawbacks linked to the enameling on faces 2 and 4 described above, in particular the need for an additional step using an annealing furnace (face 2), and the creation of the optical defect on face 4, must be eliminated.

This objective is achieved by the invention, one subject of which is a composition suitable for colored printing, via screen printing, of a sheet of polymer material intended to be part of a laminated glazing, characterized in that it comprises:
10% to 15% by weight of polyvinyl butyral,
32% to 45% by weight of at least one solvent predominantly consisting of at least one aliphatic dicarboxylic acid diester, and
at least one white pigment in an amount and with a specific surface area that are selected so that the Brookfield viscosity of the composition at 20° C. is between 9 and 13 Pa·s,

This composition has a rheology and an affinity (surface tension) with respect to the screen-printing screen and the polymer material substrate that make it perfectly suitable for this process, in particular under working atmospheric conditions, such as 10° C. to 25° C., preferably 12° C. to 15° C. and 20% to 70%, preferably at most 30% humidity, and which guarantee a printing result equivalent to printing onto flat glass. The ink thus developed makes it possible to obtain, with a single screen-printing pass, the high optical qualities, in particular the aforementioned absence of pinholes and sufficient optical density, at the same time as short touch-dry times that are compatible with an in-line process. Furthermore, the cohesive strength, or adhesion to one another, of the constituents of a laminated glazing comprising a sheet of polymer material printed by screen printing with this composition enable it to satisfy the criteria in force in all countries. The adhesion of the laminate with the printed sheet of polymer material (especially interlayer adhesive) is validated by various mechanical tests, including a torsion test and the ball-drop test, via threshold values defined by manufacturer specifications and standards,

The sheet of polymer material is an interlayer adhesive between two sheets of glass, for instance made of polyvinyl butyral, or ethylene/vinyl acetate, etc. or an interlayer adhesive between one sheet of glass and, for example, one sheet of polycarbonate or acrylic (polymethyl methacrylate or the like) for instance made of polyurethane, or consists of any other type of transparent polymer material, for example polycarbonate, acrylic, an ionomer resin, etc.

The printed sheet of polymer material also satisfies, in the laminated glazing, the regulations in terms of aging/salt fog resistance, resistance to acids or else UV radiation thus guaranteeing the durability of the finished product irrespective of its usage conditions.

The printing color obtained by this composition is variable: white, any shade of gray, blue of color index PB15:3, green of color index PG7, etc., each by addition of a selected amount, for example of the order of a few % by weight, of one or more corresponding pigments.

According to preferred features of the composition of the invention:
the polyvinyl butyral that it contains has a molecular weight evaluated by gel permeation chromatography that is centered about a value at most equal to 90,000 and, in order of increasing preference, at most equal to 80,000, 70,000, 60,000 and 50,000 and at least equal to 20,000, preferably to 30,000 in polystyrene equivalents;
the [OH] content of the polyvinyl butyral that it contains corresponds to a weight percentage of polyvinyl alcohol of between 17% and 22%;
said at least one aliphatic dicarboxylic acid diester is selected from a succinate, a glutarate or an adipate, in particular of di(C1 to C6 alkyl), preferably of dimethyl, diethyl, dipropyl or dibutyl, and particularly preferably of dimethyl, it being possible for several of these diesters to be contained in a mixture;
said at least one white pigment comprises titanium dioxide, preferably rutile titanium dioxide;
said at least one white pigment is in an amount of between 32% and 42% by weight;
said at least one solvent consists, in a minority amount, of glycol ether, such as triethylene glycol dimethyl ether;
it contains 0.5% to 3% by weight of carbon black; this constituent makes it possible to increase the optical density;
it comprises an effective amount of plasticizer as wetting agent, such as 5% to 12% by weight of a benzoate ester, a phthalate and/or its derivative, an adipate and/or its derivative, a fatty acid ester, a trioctyl trimellitate, a triacetin, a glycerol, a propylene glycol, a sorbitol or a trimethylpentanediol diisobutyrate, alone or as a mixture of several thereof;
it comprises an effective amount of a surface tension modifier that does not contain silicone, in particular 0.5% to 2% by weight of polyacrylate.

Moreover, other subjects of the invention are:
a method for printing, via screen printing, a sheet of polymer material intended to be part of a laminated glazing, in which a composition as described above is applied to the sheet, through a screen-printing screen, preferably with a thickness of the wet layer of between 10 and 50 μm, and particularly preferably at least equal to 20 μm (the industrial processability of this method is demonstrated in particular by the fact that this wet thickness is preferably achieved in a single screen-printing pass); for a sheet of polymer material that acts as an interlayer in a laminated glazing, the chemical composition of the ink has been optimized in order to guarantee that with a small deposited thickness, the printing on the interlayer guarantees a good degassing and autoclaving quality, which constitute obligatory steps for obtaining a laminated glazing;
a sheet of polymer material intended to be part of a laminated glazing, and printed, via screen printing, using a composition as described above, the sheet of polymer material preferably consisting of polyvinyl butyral or of ethylene/vinyl acetate, or of any other transparent polymer material such as polyurethane, polycarbonate, polymethyl methacrylate or other acrylic, ionomer resin, etc.; and
a laminated glazing comprising such a sheet of polymer material.

The invention is now illustrated by the following examples.

### EXAMPLE 1

By screen printing an interlayer sheet of polyvinyl butyral with an ink of composition explained in detail in the table below, and after assembling with two sheets of soda-lime float glass, a laminated glazing of high mechanical quality and having gray printing of high optical quality as described above is obtained. The “touch-dry” time of 10 min is short and compatible with a continuous in-line industrial process.

In the table below, all the proportions are indicated as weight percentages.

| | | % BY | MIN AND MAX |
|---|---|---|---|
| CONSTITUENT | CAS No. | WEIGHT | % BY WEIGHT |
| POLYVINYL BUTYRAL | 63148-65-2 | 13 | 10/15 |
| WETTING AGENT | 27987-25-3 | 9.5 | 5/12 |
| CARBON BLACK | 133386-4 | 1.5 | 0.5/3 |
| RUTILE TITANIUM | 1317-80-2 | 36 | 32/42 |
| DIOXIDE | | | |
| DIESTER | 627-93-0 | 23 | 16/45 |
| | 1119-40-0 | | |
| | 106-65-0 | | |
| GLYCOL DIETHER | 112-49-2 | 16 | 0/22 |
| SOLVENT | | | |
| SURFACE TENSION | 26376-86-3 | 1 | 0.5/2 |
| MODIFIER | | | |

The molecular weight of the polyvinyl butyral is evaluated in the following manner. Solutions of polyvinyl butyral powders at 3 g/l in tetrahydrofuran are prepared, then are injected into a gel permeation chromatography column of Waters Styragel HR4E type, 1 ml/min of tetrahydrofuran. The chromatograms are established using an evaporative light scattering detector. The broad peak observed at 7-7.1 min indicates weights, in PS equivalents, of 46,000-55,000, that is to say practically centered about 50,000.

The [OH] content of the polyvinyl butyral corresponds to a weight percentage of polyvinyl alcohol of 18%.

The wetting agent also acts as a plasticizer, that is to say that it allows a greater deformation of the printed ink film without degradation of its optical properties. Here it is dimethylcyclohexyl phthalate.

The specific surface area of the carbon black is 65 m²/g, values of 40 to 150 m²/g being suitable in general.

The diester is a mixture of 60% by weight of dimethyl glutarate, 20% by weight of dimethyl succinate and 20% by weight of dimethyl adipate.

The glycol diether solvent is triethylene glycol dimethyl ether.

The surface tension modifier is a copolymer of 2-ethylhexyl acrylate; it does not contain silicone.

The Brookfield viscosity of the ink at 20° C. is 11 Pa·s, values between 9 and 13 Pa·s being suitable within the context of the invention. This measurement is carried out in the following manner. The viscosity of the ink is reduced to a stable value by rotation for at least 8 hours of a roller in the ink. A sample of the latter is withdrawn, on which the viscosity is measured using a cone-plate viscometer.

Using an X-Rite 341 device, an optical density of greater than 3 is measured for the printed gray patterns, on the laminated glazing. The required opacity is therefore obtained.

The resolution of the printed patterns is satisfactory.

The adhesion of the printed interlayer laminate is demonstrated by satisfying the “ball drop” tests according to Regulation No. 43, Addendum 42, of the E/ECE/324, E/ECE/TRANS/505 agreement, concerning the adoption of uniform technical prescriptions for wheeled vehicles, equipment and parts which can be fitted and/or be used on wheeled vehicles and the conditions for reciprocal recognition of approvals granted on the basis of these prescriptions.

1. A laminated glazing comprising a sheet of polymer material color printed, via screen printing, using a composition comprising:
10% to 15% by weight of polyvinyl butyral;
32% to 45% by weight of at least one solvent predominantly consisting of at least one aliphatic dicarboxylic acid diester, and
at least one white pigment in an amount and with a specific surface area that are selected so that the Brookfield viscosity of the composition at 20° C. is between 9 and 13 Pa·s.

2. The laminated glazing as claimed in claim 1, wherein the polyvinyl butyral of the composition has a molecular weight evaluated by gel permeation chromatography that is centered about a value at most equal to 90,000 in polystyrene equivalents.

3. The laminated glazing as claimed in claim 1, wherein the polyvinyl butyral of the composition has a molecular weight evaluated by gel permeation chromatography that is centered about a value at least equal to 20,000, in polystyrene equivalents.

4. The laminated glazing as claimed in claim 1, wherein the [OH] content of the polyvinyl butyral of the composition corresponds to a weight percentage of polyvinyl alcohol of between 17% and 22%.

5. The laminated glazing as claimed in claim 1, wherein said at least one aliphatic dicarboxylic acid diester is selected from a succinate, a glutarate and an adipate.

6. The laminated glazing as claimed in claim 1, wherein said at least one white pigment comprises titanium dioxide.

7. The laminated glazing as claimed in claim 1, wherein said at least one white pigment comprises rutile titanium dioxide.

8. The laminated glazing as claimed in claim 1, wherein said at least one white pigment is in an amount of between 32% and 42% by weight of the composition.

9. The laminated glazing as claimed in claim 1, wherein said at least one solvent consists, in a minority amount, of glycol ether.

10. The laminated glazing as claimed in claim 1, wherein said at least one solvent consists, in a minority amount, of triethylene glycol dimethyl ether,

11. The laminated glazing as claimed in claim 1, wherein the composition contains 0.5% to 3% by weight of carbon black.

12. The laminated glazing as claimed in claim 1, wherein the composition comprises an effective amount of plasticizer as wetting agent.

13. The laminated glazing as claimed in claim 1, wherein the composition comprises an effective amount of a surface tension modifier that does not contain silicone.

14. A method of printing, via screen printing, a sheet of polymer material for a laminated glazing as claimed in claim 1, the method comprising applying to the sheet of polymer, through a screen-printing screen, is a composition comprising:
10% to 15% by weight of polyvinyl butyral;
32% to 45% by weight of at least one solvent predominantly consisting of at least one aliphatic dicarboxylic acid diester, and
at least one white pigment in an amount and with a specific surface area that are selected so that the Brookfield viscosity of the composition at 20° C. is between 9 and 13 Pa·s.

15. The method as claimed in claim 14, characterized in that wherein the thickness of the wet layer of the composition applied is between 10 and 50 μm.

16. A sheet of polymer material for a laminated glazing as claimed in claim 1, and printed, via screen printing, using a composition comprising:
10% to 15% by weight of polyvinyl butyral;
32% to 45% by weight of at least one solvent predominantly consisting of at least one aliphatic dicarboxylic acid diester, and
at least one white pigment in an amount and with a specific surface area that are selected so that the Brookfield viscosity of the composition at 20° C. is between 9 and 13 Pa·s.

17. The laminated glazing as claimed in claim 2, wherein the value is at most equal to 80,000.

18. The laminated glazing as claimed in claim 17, wherein the value is at most equal to 70,000.

19. The laminated glazing as claimed in claim 18, wherein the value is at most equal to 60,000.

20. The laminated glazing as claimed in claim 18, wherein the value is at most equal to 50,000.

21. The laminated glazing as claimed in claim 3, wherein the polyvinyl butyral of the composition has a molecular weight evaluated by gel permeation chromatography that is centered about a value at least equal to 30,000.
